(19) United States
(12) Patent Application Publication
(10) Pub. No.: US 2007/0069943 A1
(43) Pub. Date: Mar. 29, 2007

(54) Signal processing system and method

(76) Inventors: Bruce W. Adams, Cloverdale (CA); Peter R. H. McConnell, Vancouver (CA)

Correspondence Address: GOTTLIEB RACKMAN & REISMAN PC, 270 MADISON AVENUE, 8TH FLOOR, NEW YORK, NY, 100160601, US

(21) Appl. No.: 10/548,348

(22) PCT Filed: Mar. 12, 2004
(86) PCT No.: PCT/CA04/00363

§ 371 Date: Nov. 20, 2006

(30) Foreign Application Priority Data
Mar. 12, 2003 (US) 60453479

(51) Int. Cl. G01S 13/08

(52) U.S. Cl. 342/130

(57) ABSTRACT

The present invention provides a signal processing system and a method for performing the processing of information therewith. This signal processing system is designed for use with a sensing system, in which an encoded signal is directed to a test sample, and the resultant signals are collected and correlated with the encoded signal, thereby enabling the detection of a test samples response to the transmitted signals, wherein this may enable an understanding of the test sample to be determined. The signal processing system provides control signals to the sensing system in order to control both the format of signals being transmitted to a test sample and detection of signals received from a test sample resulting from this transmission and the subsequent correlation therebetween. By controlling both the transmitted and detected signals, the signal processing system can correlate this information in order to improve the detection capability, thereby providing an improved means of analysing a test sample.

### FIELD OF THE INVENTION

The present invention pertains to the field of signal processing, having particular regard to a signal processing system for use with a sensing system enabling control thereof and enhanced signal detection.

### BACKGROUND

The detection of resultant signals of targets based on previously transmitted incident signals has been used extensively to enable the identification, and the composition of the material of these targets. In many cases the reflected, or resultant signals retain the characteristics, such as frequency and type of signal of the incident signals. In other cases the resultant signals may include, for example, additional frequencies other than the incident frequencies. These additional frequencies together with the incident signals may provide information on the composition of the target substance, possibly including concentrations of the elements forming the substance.

A particular embodiment of a sensing system is a spectrometer, and having regard to reflection and fluorescence, the detection of signals reflected with the same frequency as the incident signal is typically easier than with other frequencies generated, for example fluorescence. Fluorescence may be transmitted over a wide frequency range, with an amplitude level significantly lower that the signal reflected at the same frequency as the incident frequency. The strength of the fluorescence signal emitted by a substance can be below the noise level of a system and may therefore not be possible to identify or evaluate, wherein this noise may be ambient noise and/or electrical noise within the system.

U.S. Pat. No. 6,002,477 describes a spectrophotometer device which provides a means for reducing the effect of noise on the detected spectral signature, wherein this reduction depends on the determination of the level of noise in the system in order to reduce its effect on the detection of energy detected from a substance. The spectrophotometer measures the intensity of the light beam generated by each burst of light after that beam interacts with the sample. Each such light beam may be divided into first and second parts prior to interaction with the sample, and the optical system is arranged to direct the first part to the sample and to direct the second part to a second detector for conducting a reference measurement. A dark signal measurement may be conducted immediately before or after each burst of light. Thus by having a reference signal determining the noise within the system provides a means for isolating the received signal. This form of noise compensation, however, essentially performs a subtraction of signals in order to identify the desired signals, wherein this type of technique may result in the removal of a desired signal.

Hence there is a need for a new signal processing system and technique enabling the detection of low level emissions from substances, that are not easily detected due to noise within the detection system, wherein the emissions being detected are resultant of interaction with electromagnetic radiation of a predetermined type.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a signal processing system and method. In accordance with an aspect of the present invention, there is provided a signal processing system for controlling a sensing system enabling the detection of signals in the presence of noise, said sensing system including an energy source for generating an incident signal, an emission processing system for directing the incident signal to a test sample, a received signal processing system for collecting one or more resultant signals from the test sample in response to the incident signal and a detector for converting the one or more resultant signals into electrical signals, said signal processing system comprising: an emission control system operatively connected to the energy source and the received signal processing system, said emission control system transmitting first control signals to the energy source, said energy source thereby producing an encoded incident signal in a pulse format, said emission control system sending second control signals to the received signal processing system for controlling the collection of the one or more resultant signals for subsequent conversion into electrical signals by the detector; and a DSP received signal processing system for match correlating the electrical signals from the detector with the encoded incident signal thereby enabling isolation of a response of the test sample to the incident signal transmitted thereto in the presence of noise.

### BRIEF DESCRIPTION OF THE FIGURES

FIG. 1 is a schematic of a system incorporating a signal processing system according to one embodiment of the present invention.

FIG. 2 is a schematic diagram of a signal pulse processing system integrated into the signal processing system according to one embodiment of the present invention.

FIG. 3 illustrates the symbol rate (Fₛ) for integration into the bank of narrowband digital filters of FIG. 2, according to one embodiment of the present invention.

FIG. 4 is a schematic representation of a time-domain correlation model that can be used in the pulse code correlator of FIG. 2, according to one embodiment of the present invention.

FIG. 5 is a schematic of a signal processing system according to one embodiment of the present invention, wherein the signal processing system is configured to operate as part of a stand-alone system.

FIG. 6 demonstrates On-Off keyed signal with a 0 dB signal to noise ratio, using pulse amplitude modulation detection.

FIG. 7 demonstrates signal detection using frequency domain detection.

FIG. 8 demonstrates the results of the time domain correlation output from binary pulse coding signal detection.

FIG. 9 is a schematic representation of a pulse coding channel model.

FIG. 10 depicts the detector output using a linear FM Chirp, which is a 125 msec wide rectangular function, swept from 500 Hz to 3500 Hz and sampled at 8000 samples/sec.

FIG. 11 demonstrates the use of a linear FM pulse coding technique where the pulse duration was left at 0.125 seconds and the bandwidth was 1600 Hz for a time bandwidth product (TBP) of 200. A log scale of the detector was calculated as; P=20×log s, where s is the time domain output of the matched filter.

FIG. 12 demonstrates the use of a linear FM pulse coding technique as in FIG. 11 for a TBP of 800.

FIG. 13 demonstrates the use of a linear FM pulse coding technique as in FIG. 11 for a TBP of 2250.

FIG. 14 is a time domain plot for the case of a TBP of 2250, where the detector amplitude was plotted.

FIG. 15 is illustrates an optical system having with the signal processing system according to the present invention integrated therein.

### DETAILED DESCRIPTION OF THE INVENTION

### Definitions

The phrase “weak signal detection” refers to techniques used to enable measurement of low intensity emission radiation from a sample. For any given signal to noise ratio, the information error rate can be lowered by increasing the bandwidth used to transfer the information. The signal bandwidths are spread prior to transmission in the noisy channel, and then despread upon reception. This process results in what is called Processing Gain.

The term “signal spreading” refers to a number of means of spreading the signal, including Linear Frequency Modulation (sometimes called Chirp Modulation) and Direct Sequence methods and other techniques.

The term “signal despreading” refers to a process that is accomplished by correlating the received'signal with a similar local reference signal using a Correlation Receiver or Matched Filter receiver technique. When the two signals are matched, the spread signal is collapsed to its original bandwidth before spreading, whereas any unmatched signal is spread by the local reference to essentially the transmission bandwidth. This filter then rejects all but desired signals. Thus, in order to optimize a desired signal within its interference (thermal noise in the detection system, ambient system induced noise, AC line noise, for example), a matched filter receiver enhances the signal while suppressing the effects of all other inputs, including noise.

Unless defined otherwise, all technical and scientific terms used herein have the same meaning as commonly understood by one of ordinary skill in the art to which this invention belongs.

The present invention provides a signal processing system and a method for performing the processing of information therewith. This signal processing system is designed for use with a sensing system, in which an encoded signal is directed to a test sample, and the resultant signals are collected and correlated with the encoded signal, thereby enabling the detection of a test samples response to the transmitted signals, wherein this may enable an understanding of the test sample to be determined. Such signals may be electromagnetic or acoustic, including sensing systems like for example, a spectrometer, a photo-acoustic sensing system, an X-Ray system, or other sensing system for directing and detecting electromagnetic radiation as would be readily understood by a worker skilled in the art. The signal processing system provides control signals to the sensing system in order to control both the format of signals being transmitted to a test sample and detection of signals received from a test sample resulting from this transmission and the subsequent correlation therebetween. By controlling both the transmitted and detected signals, the signal processing system can correlate this information in order to improve the detection capability, thereby providing an improved means of analysing a test sample.

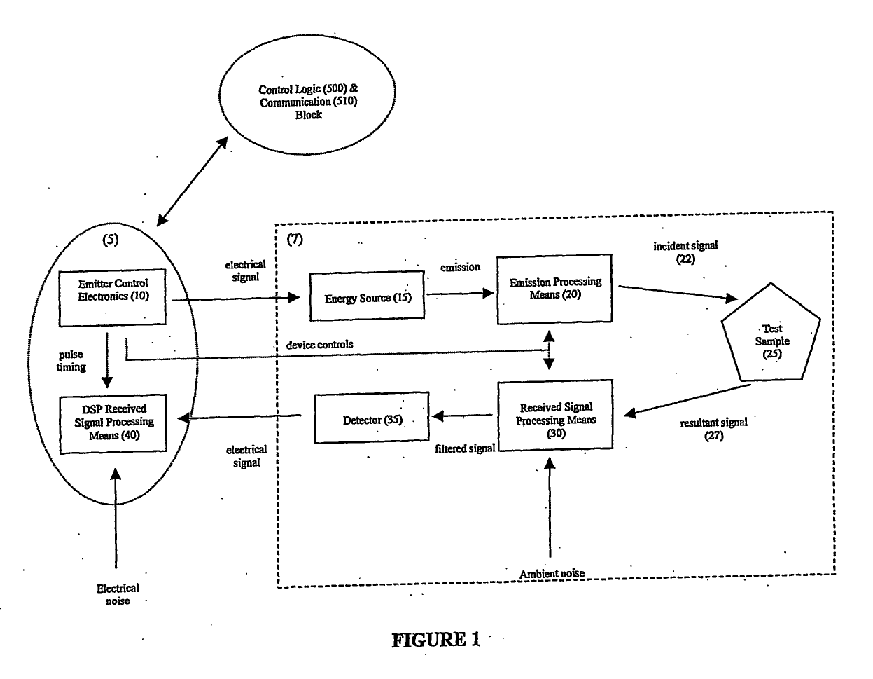

As an example, the interconnectivity of the signal processing system 5 and a sensing system 7 is illustrated in FIG. 1. The sensing system comprises an energy source 15 which is controlled by the signal processing system 5 (specifically the emitter control electronics 10), to emit one or more incident signals 22 and emission processing means 20 which is controlled by the signal processing system 5 (specifically the emitter control electronics 10) to receive the incident signals from the energy source 15 and to deliver one or more of the incident signals in an encoded format to the test sample 25. In one embodiment, the emission processing means 20 can comprise a means for isolating one or more illumination wavelengths and emitter means that orient and focus the illumination wavelength(s) onto the test sample 25. In one embodiment, wherein the energy source is an electromagnetic illumination source, this interaction between the illumination and the test sample can take the from of reflected electromagnetic radiation and fluorescence radiation which is generated as a result of the nature of the test sample. In some cases, these electromagnetic signatures result from the main elements within the test sample or some material resident in the test sample. For example, if the test sample is water, the electromagnetic signatures can be results from the water itself and/or suspended solids or dissolved compounds within the water sample, for example.

The sensing system further comprises received signal processing means 30 which is controlled by the signal processing system 5 (specifically the emitter control electronics 10) to collect and isolate one or more resultant signals 27 from the test sample 25 due to the previously transmitted incident signals thereto. The received signal processing means 30 can comprise a detector system for collecting the resultant signal from the test sample 25 and a means for isolating one or more of the resultant signals. Additionally, the sensing system comprises a detector 35 to sense and convert to an electrical signal, the resultant signal which has been transmitted by the received signal processing means 30 and a DSP received signal processing means 40, which is a component of the signal processing system 5, to perform match filtering (or more specifically the matched correlation) on the output of the detector 35. The match filtering of the resultant signal is performed based on the received electrical signals from the detector 35 and control parameters from the emitter control electronics 10 representing the encoded format of the incident signals. In one embodiment, a signal strength estimate can be passed to the control block 500 that can perform a task including real-time decision making based on the current value of the signal strength and/or pass it further to the communication block 510 for subsequent transmission.

With further regard to FIG. 1, there are various locations for noise or interference to enter the sensing system 7 and the signal processing system 5, wherein this interference can decrease the ability to detect signals received from the test sample due to transmission of encoded incident signals thereto. For example ambient noise can enter the sensing system through the received signal processing means 30 and electrical noise can enter the signal processing system through the DSP received signal processing means 40. The signal processing system can provide a means for the encoding of the incident signal and the matched filtering (or correlation) of the resultant signal in relation to the encoded incident signal. As such, the signal processing system can enable improved detection of the resultant signals resulting from the transmission of encoded incident signals the test sample. This improved detection capability results from noise suppression and signal enhancement that is achieved by transmitting an incident signal with a coded waveform to the test sample and correlating the resultant signal from the test sample with a replica of the transmitted waveform to generate a correlation output that is proportional to the degree of resultant signal resulting from the interaction of the incident signal with the test sample. In one example, a test sample is illuminated by an energy source, the correlation output is proportional to the degree of reflectance and/or fluorescence resulting from the interaction of the illumination with the test sample.

Having particular regard to fluorescence, it is a phenomenon where a sample is illuminated by energy of wavelength λ₀ which is absorbed by the sample and radiation of wavelength λ₁ is emitted by the sample where λ₁>λ₀. If the emission occurs during the excitation phase or within a very short period of time after the excitation, this process is commonly called fluorescence and the time constant is usually less than 10-8 seconds. If the excitation pulse is very short in duration, the intensity of the fluorescent emission exhibits an exponential time decay profile where the time-constant of the fluorescence decay td is characteristic of the sample being excited. The tail of the exponential decay in the emission waveform e^{-(t/τd)} where τ_{d} is the decay time constant for the sample being illuminated. For a single atomic or molecular sample being illuminated, the exponential terms is proportional to the probability that an emission photon will be emitted some time τ_{d} after the application of the excitation energy. Since the sample comprises a very, very large number of atomic or molecular constituents; the emission characteristic becomes the ensemble average of the whole sample. In this case, one actually sees the light intensity of the fluorescent radiation continuous in time for a period of time after application of the excitation and subsequent decay of this intensity. When applying coded excitations of illumination to a test sample, one is capable of observing the same ensemble average decay characteristic as mentioned above. It this case, coded pulses which are much longer than the fluorescence decay constant τ_{d} can be used to “modulate” the excitation radiation and a pulse compression technique as described below can be used to compress the signals generated by the emission radiation. The use of pulse compression techniques in this case typically only work for the case where the test sample being excited contains a very large number of atomic or molecular components that contribute to the fluorescence.

Signal Processing System

The signal processing system can be used to control the energy source, the emission processing means and the received signal processing means or any combination thereof. This control provided by the signal processing system can enable the detection of one or more resultant signals in relation to one or more incident signals transmitted to the test sample, wherein this detection can be performed in the presence of noise introduced into the system. The signal processing system comprises emitter control electronics, which provide a means for controlling the transmitted incident signal (emission processing system) and the received signal processing system. In addition, the signal processing system comprises a received signal processing means that enables the signal processing system to correlate the resultant signal with the initially transmitted incident signal. As an example, the signal processing system of the present invention can provide a means for identifying reflectance and fluorescence from a test sample due to its illumination with a predetermined wavelength of light, wherein the sensing'system being controlled in this example can be a form of spectrometer.

The following description is described with direct application to the integration of the signal processing system according to the present invention with a light sensing system, for example a spectrometer. A worker skilled in the art would readily understand how to integrate the signal processing system in order to control other sensing systems including a photo-acoustic sensing system or an X-Ray sensing system or other form of sensing system as would be readily understood by a worker skilled in the art.

In one embodiment, the emitter control electronics which control the illumination radiation, perform tasks including: supplying electrical power and driving circuitry to convert electrical energy into illumination energy, controlling the amplitude and timing of the signal source pulses, controlling devices which filter, focus, or mechanically pulse the illumination radiation, for example, a filter, monochromator, collimator and/or a chopper. In addition, the emitter control electronics provides a means for controlling the received signal processing means, enabling the isolation of reflectance and fluorescence signal wavelengths from the test sample due to its illumination. For example, the incorporation of a monochromator into the received signal processing means can provide a means for isolating the desired wavelengths. The functionality of the monochromator can be controlled by the received signal processing system.

A form of coding function can be employed by the emitter control electronics in order to encode the illumination signal prior to interaction with the test sample, wherein this coding function can be provided by any number of signal modulation techniques. For example, pulse code software can be used to create a synchronous pulse for direct modulation of the signal control device frequency (pulse frequency modulation, PFM). With PFM the frequency of the pulses is modulated in order to encode the desired information. Pulse code software can be used to create a synchronous pulse for direct modulation of the signal control device amplitude (pulse amplitude modulation, PAM), wherein with PAM the amplitude of the pulses is modulated in order to encode the desired information. In addition, pulse code software can be used to create synchronous pulse for direct modulation of the signal control device pulse width (pulse width modulation, PWM). With PWM the width of the pulses is modulated in order to encode the desired modulation. Finally the illumination signal may be encoded using a function generator to create a fixed synchronous pulse enabling pulse rate and amplitude modulation, in addition to a mechanical encoder driver to create a synchronous pulse for an indirect signal modulator, for example a chopper, shutter, galvomirror etc.

In one embodiment of the invention the coding function that is employed by the emitter control electronics is binary phase shift keying (BPSK) which is a digital modulation format. BPSK is a modulation technique that can be extremely effective for the reception of weak signals. Using BPSK modulation, the phase of the carrier signal is shifted 180° in accordance with a digital bit stream. The digital coding scheme of BPSK is as follows, a “1” causes a phase transition of the carrier signal (180°) and a “0” does not does not produce a phase transition. Using this modulation technique a receiver performs a differentially coherent detection process in which the phase of each bit is compared to the phase of the preceding bit. Using BPSK modulation may produce an improved signal-to-noise advantage when compared to other modulation techniques, for example on-off keying.

In one embodiment of the invention, the DSP received signal processing means enables matched filter correlation between electrical signals received from the detector and the corresponding time period as defined by the emission control electronics. This correlation between transmitted and received signals can provide a means for enhanced identification of received signals over the noise (ambient noise and/or electrical noise, for example) that may enter the sensing system or the signal processing system. Filtering and time averaging of received signals, synchronized and matched with the emitted pulse sequence can enhance the signal-to-noise ratio (SNR) and can improve the confidence in the measurement of the sample response at a wavelength or wavelengths of interest.

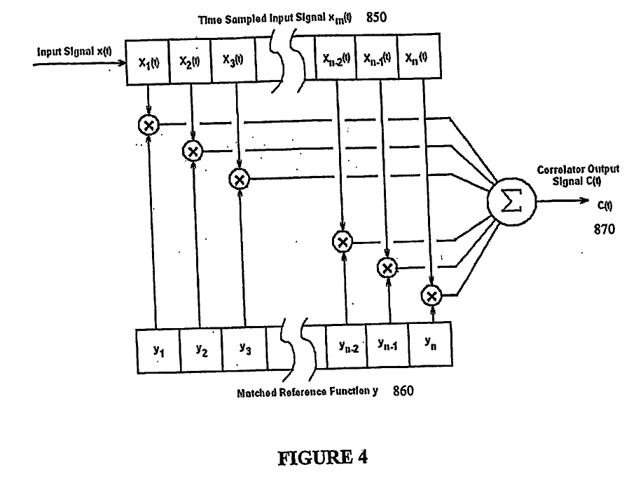

A matched filter is an exact copy or reference of the signal of interest. The reference is correlated with the input signal, with this procedure basically being a sum of the products of the signal multiplied by the reference over the total duration of the filter. This procedure is depicted in FIG. 4. When the reference signal and the signal of interest are matched, the correlation (convolution) sum typically peaks relative to the non-matched sums providing a means for identifying the signal over the external noise within the sensing system and the signal processing system. In one embodiment of the present invention, a form of matched filtering can be provided by a bank of narrowband filters centered at intervals of the pulse rate can capture more harmonics from the pulse spectrum, and thus may provide a means for improved signal pulse energy estimation and subsequent identification of the detected wavelength. This results from the fact that more of the energy in the received signal is used in determining the correlation.

In one embodiment of the present invention, if the time domain spreading function is represented by F(ω) and the received signal is represented by H(ω), then the output of the matched filter receiver can be obtained using a digital signal processor:

$$s ( t ) = {\int }_{- ∞}^{+ ∞} F ( ω ) H ( ω ) {ⅇ}^{- j ω t} ⅆ f where \text{:} ω = 2 π f$$

In this equation F(ω) is the Fourier Transform of the input signal f(t) and H(ω) is the Fourier Transform of the receiver linear filter h(t). In a matched filter, the receiver linear filter H(ω) is adjusted to optimise the peak signal-to-noise ratio of the receiver output s(t) for a specific input signal f(t). When the receiver linear filter response H(ω) is given by:
H(ω)=KF*(ω)e^{-jωt}^{₀}
then the output signal-to-noise ratio is maximised and the receiver filter response, H(ω) is matched to the input signal f(t), wherein f(t) has the Fourier Transform F(ω). The two above equations are taken from “Information Transmission, Modulation and Noise, A Unified Approach to Communication Systems”; Schwartz, Mischa; Third Edition. A matched filter receiver enables one to potentially maximise the signal-to-noise ratio of the output signal s(t), the detection of which is desired. Thus a matched filter receiver may provide optimum detection of the output signal. Since a matched filter receiver is a linear system, s(t) is directly proportional to the intensity of the reflectance and fluorescence illumination on the detector. The use of a matched filter can enable one to detect weak signals in the presence of noise (external and internal noise of the system), which may not be detectable using other systems.

In one embodiment of the invention, the signal processing system involves both analog front-end and digital back-end tasks. In general the analog processing tasks are concerned with recovering the small sensor signals and applying highly selective filtering operations. The digital domain tasks are concerned with further signal filtering as well as analysis functions, in relation to energy detection and data output. To potentially minimize the interference and to provide immunity against shot noise, the illumination signal can be modulated by a frequency of typically a few hundred Hz. The analog section can be designed to high gain amplify and prefilter the detector output and recover the modulation frequency. Utilizing these signals, a narrowband tracking filter can provide the high selectivity for modulated signal recovery. The output of the narrowband filter, after amplification, is analog/digital converted and input into a DSP that in real time, can perform the back-end tasks of filtering, energy detection, averaging and converting the results into usable data. The filtering can further enhance the rejection of a/c noise and harmonic distortion, which may have been introduced in the final stages of analog processing. The filtering can be followed by an averaging energy detector, which outputs the values proportional to the energy of the sensor signal. These values can be sent to a host device, for example a computer, in short intervals, where they can be stored and processed for further analysis.

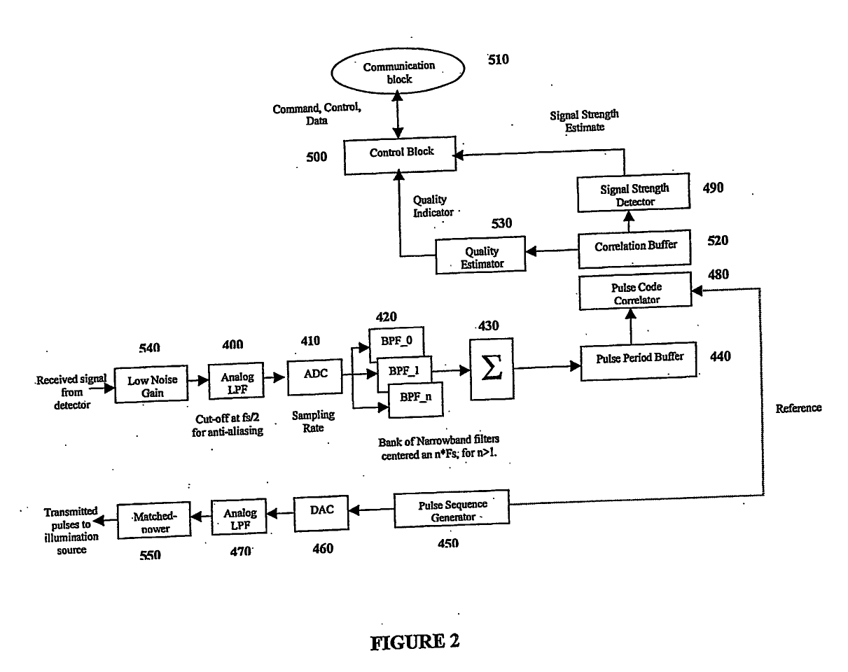

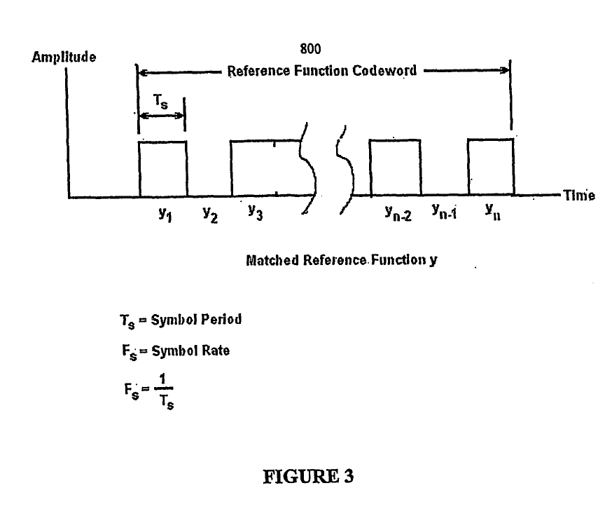

In another embodiment of the present invention, the signal processing system can be designed as illustrated in FIG. 2. Initially, a pulse sequence generator 450 transmits a reference signal to the pulse code correlator 480 and further transmits a digital signal defining the generated sequence to a digital to analog converter 460. The resulting analog pulses are sent to the illumination source upon passing through an analog low pass filter 470 and the illumination source subsequently illuminates the test sample based on these pulses. Upon the collection and detection of the emitted radiation from the test sample due to its illumination, the pulses generated by the detector as a result of radiation detection are input to an analog low pass filter (LPF) 400, which transmits the filtered information to a analog to digital converter (ADC) 410. The analog LPF can suppress frequencies over fₛ/2, for example, where fₛ is the sampling rate of the ADC thereby providing anti-aliasing filtering. This digitized information is sent to a bank of narrowband digital filters 420, wherein each filter is matched to one of the lines in the pulse sequence spectrum (input signal pulse) and subsequently transmitted to a summation module 430. Each filter is centered at n*Fₛ, where n is an integer that goes from 1 to N, where N is the maximum number of filters. FIG. 3 shows a time domain representation of the pulse code signal. These are often referred to as pseudo-random binary sequences and comprise n random bits that define a “codeword” 800. Each of the n bits which form the codeword are referred to as a “symbol” which has a time duration Tₛ, which is often referred to as the symbol period. The symbol rate Fₛ is the rate at which the symbols are transmitted and is given by Fₛ=1/Tₛ. Such a method allows the matching of a received signal with a replica or match of the reference coded waveform in order to identify the signal over the external noise within the system and can be called matched filtering.

The individual filters implemented in the bank of narrowband digital filters 420 essentially filter the fundamental frequency component and the harmonic frequency components of the reference pulse, and they are summed at the summation module 430 to obtain the individual spectral components of the signal, thereby most of the power in the filtered received signal is a result of the coded illumination signal that was transmitted to the test sample. The sums from the summation module 430 are stored in the filter-pulse period buffer 440 and are correlated to the transmitted signal in the pulse code correlator 480 and the result is stored in the correlation buffer 520. FIG. 4 provides a schematic representation of a time-domain correlation model that could be used in the pulse code correlator, however other correlation models may be used as would be readily understood by a worker skilled in the art. The signal strength detector 490 and quality estimator 530 can calculate the signal strength estimate and quality indicator data based on the information in the correlation buffer 520 and subsequently send signal strength estimate and the quality indicator data to the control logic 500 of the signal processing system. The control logic 500 provides a means to perform scheduling control and configuration control of the signal processing system. The control logic 500 can also perform real-time decisions based on the current status of the sensing system and the signal processing system. The signal strength estimate and quality indicator data can subsequently be transmitted to a computing device located on a personal computer or a central controller, for example, via communication block 510 or other means, in order to be organised into a usable and presentable format, for example generating a graphical representation of the collected information and/or storing data on a database.

Having further regard to FIG. 4, the time sampled input signal xₘ(t) 850 is stored in a shift register of length n samples, and shift register can be referred to as a “tapped delay line” as it contains the most recent sample x₁(t) and the last n-1 samples. The n samples in the “tapped delay line” are multiplied by corresponding samples in the matched reference function register Y 860 containing the n samples of the correlation reference function that represents the transmitted pulse sequence. The product of the corresponding samples in the “tapped delay line”, namely each time sampled input signal times the corresponding matched reference function, are summed. This sum represents the correlation output signal C(t) 870 for the sampled data in the “tapped delay line” at that instant in time. This form of correlation can be used in embodiments of the present invention that implement pulse code transmission schemes or with other coding means such as “linear frequency modulation”, for example. The matched reference function is essentially a time sampled replica of the signal that was generated for controlling the illumination of the test sample.

With further reference to FIG. 4; the next sampled data value xₒ is placed into the “tapped delay line” and this results' in the previous samples in the “tapped delay line” being shifted to the right in the FIG. 4. Specifically, the new sample xₒ becomes x₁(t), sample, sample x₁(t), becomes x₂(t) and so on, wherein sample xₙ is discarded from the “tapped delay line”. The corresponding samples in the “tapped delay line”, namely each time sampled input signal, and the corresponding matched reference function are again multiplied and summed to provide the next correlation result. This process continues as new samples are added to the “tapped delay line”, and the result is the time sampled correlation result.

In one embodiment of the invention, the functionality of the signal processing system can further include an alarm setting, wherein one or more actions can be performed upon the activation of an alarm setting. For example, the signal processing system may constantly correlate and perform statistical analyses on the processed data and once a predetermined level of change in the received signal is reached, the signal processing system can activate the alarm setting. The activation of an alarm setting may result in a message being sent to personnel that are monitoring the sensing system and signal processing system, for example in the form of a warning light, buzzer, email, cell-phone message or voice call to the phone or alternately may activate another procedure, for example sample extraction.

In one embodiment digital signal processing algorithms can be implemented in standard digital signal processing chips which are integrated into the signal processing system thereby enabling the overall cost of devices integrating the signal processing system of the present invention to be relatively low.

The signal processing system can be incorporated into a computer system in the form of a circuit board that can be installed in a computing device, for example, wherein the computer can provide a means for manipulating and organising the received information after matched filtering into a format that is easy to interpret by the operators of the system, for example. Alternately, the signal processing system can comprise stand alone hardware providing a means for the signal processing system to function independently.

Stand-Alone Signal Processing System

In one embodiment of the present invention, the signal processing system can be designed in a stand-alone configuration. In this type of stand-alone configuration, the signal processing system can further include the capability of interconnecting with a global communication system, for example the Internet or for networking within a local area network (LAN). This type of interconnection with a communication network can enable the collection of information from a plurality of test sites by a central station, thereby potentially reducing the personnel required for the collection of this test data.

As would be known to a worker skilled in the art, depending on the communication system (LAN, WAN, Internet) by which the information from the systems is transmitted and the desired level of security desired for the information, varying levels of encryption of the data may be required and implemented.

In this embodiment, the stand-alone signal processing system comprises a DSP block, a transmitter and receiver block, a micro-controller block (MCU), a communication block and a digital and analog power supply block.

In this embodiment the DSP block comprises a digital signal processing chip and external memories. The DSP block performs the computation algorithms for fast, real-time processing of signals being transferred from the detector(s). This block also generates signals that are capable of modulating the energy source; wherein this modulation signal can be multiplexed to multiple energy sources if required. However, each detector, if there is more than one, has a separate channel into the DSP block for the transmission of information relating to the received signal. In addition, the DSP block can control the device(s) that mechanically pulses the illumination radiation, for example, a chopper. As would be known to a worker skilled in the art, the required processing speed of the DSP chip can be determined by the estimated amount and frequency of the incoming data that is to be processed. In this manner an appropriate chip can be determined based on its processing speed for example the number of Hertz that the DSP operates, 40 Hz, 60 Hz and so on.

According to this embodiment, the transmitter and receiver block comprises an analog-to-digital converter (ADC), digital-to-analog converter (DAC) and low-pass filters, wherein these filters enable anti-aliasing of the received signal. In one embodiment, a number of light emitting diodes (LEDs) or laser diodes can be used as the energy source for the sensing system. In this embodiment, the transmitter and receiver block further comprises a multiplexer and high power amplifiers, wherein the multiplexer can enable the transmission of signals for the activation of the multiple energy sources independently and the high power amplifiers provide a means for providing sufficient energy in order to activate these energy sources such that their maximum power output is obtained. In one embodiment of the present invention two Texas Instruments's CODECs (coder/decoder), TLV320AIC20 are used as the analog to digital converters. In this example the TLV320AIC20 comprises two analog to digital converters and two digital to analog converters. Thus by the incorporation of these two CODECs into the stand alone signal processing system, there is provided 4 independent input channels and any number of output channels by using a multiplexer.

An example of the communication block of the stand alone signal processing system comprises a multiple network controller card, for example, an ethernet chip ,wireless network chip, and/or USB chip, which enables the interconnection of the stand alone signal processing system to a communication network, for example a local area network (LAN), a wide area network (WAN) for example, GSM/GPRS or CDMA, or a local wireless network (for example Bluetooth™ or IEEE 802.11). A worker skilled in the art would understand the format and type of chip or card that is required for the desired network connection. In addition the network block further can comprise serial interface chips, for example RS-232 ports which can provide serial interfaces to other components or systems, for example a computer or a serial modem, for example dial-up or wireless type modem or a serial connection to a monochromator. The communication block therefore can provide a means for a remote computing system or a local computing system to access information collected by the signal processing system in addition to the amendment or replacement of algorithms that operate on the signal processing system in addition to configuration data. For example, if a stand alone signal processing system is remotely located, though interconnection with the Internet, for example, personnel can modify the operations of the signal processing system in addition to access data thereon in a remote manner.

Furthermore, in this stand-alone embodiment, the micro-controller unit (MCU) block comprises a MCU chip, which may be an 8-bit, 16-bit or 32-bit chip, for example, and external memory. The MCU block manages the DSP block and the communication block wherein the MCU block collects processed data from the DSP block and forwards this information to the communication block. Devices which filter and/or focus the illumination radiation and received signal, for example signal filters or monochromators, can be controlled by the MCU block. The MCU block may additionally perform statistical analyses on the data and may possibly activate an alarm setting. For example, an alarm setting may be activated if the turbidity level of the test sample exceeds a predetermined level, wherein this alarm activation may comprise the collecting of a sample for a more detailed analysis or the notification of personnel of the alarm activation. In the case where software updates to the DSP block are required, for example the modification of the match filtering procedure, the MCU block can manage the remote software updates of the DSP code, for example. The type of MCU chip incorporated into the MCU block may vary depending on the volume of information that is to be processed for example, as would be known to a worker skilled in the art. In one embodiment, the MCU chip has an interface enabling it to control two precision bi-polar DC motors, wherein the motor interface can be optically isolated from the pins of the MCU chip in order to limit the danger of damaging the MCU chip, for example. In another embodiment, the MCU chip can have a number of general output pins that can be used for additional devices, for example controlling valves, temperature sensors or other forms of sensors outside of the sensing system being controlled by the signal processing system. In one embodiment, the programming of the MCU chip can be provided by an ISP interface which can be provided by the communication block as previously described. In a further embodiment of the invention, the MCU block further comprises a FPGA (field programmable gate array) chip and/or CPLD (complex programmable logic device) chip, real-time clock, and a reset chip, wherein the FPGA/CPLD are re-programmable integrated circuits that provide additional functionality to the system such as address decoding logic, board reset logic, and/or specialized algorithms.

The digital and analog power supply block of the stand alone signal processing system can provide regulated DC power at a variety of levels depending on that required by the components of the stand alone signal processing system. In one example, the input power to this stand alone system may be supplied by an unregulated or varying power supply, for example a wall plug. The digital and analog power supply block comprises elements which can regulate the input power and subsequently generate the required analog and digital voltage levels for each component of the stand alone signal processing system. As examples, elements that can enable the adjustment of the input power comprise transformers, AC-DC converters or any other power regulation elements, as would be known to a worker skilled in the art. The digital and analog power supply block can also provide battery backup circuitry and power failure detection circuitry.

The stand-alone signal processing system has a variety software operating thereon, wherein this is typically called firmware, that enables the stand alone system with its functionality. It would be readily understood to a worker skilled in the art that particular types of firmware may or may not be present on any one configuration of the stand alone signal processing system, wherein required firmware can be determined based on the desired functionality of a particular stand alone signal processing system. For example, functionality of the firmware which can be running on the stand alone system can be selected from the group comprising: signal transmission and detection based on a desired coding function, for example BPSK principals; digital filtering used to perform the initial clean up of the received coded pulses of signal energy; autocorrelation to perform the secondary clean up of the received coded pulses; signal to noise estimation based on autocorrelation results; microcontroller/DSP communication interface software; microcontroller/serial port communication interface software; software drivers for the codecs; microcontroller'loading software designed to read a hex file and load the DSP with its contents, for example instructions regarding its functionality; FPGA/CPLD software designed to create the glue-logic to interface the microcontroller, the multiple network controller and the external memory chips; microcontroller's driver enabling the operation of a dial-up and/or wireless modem.

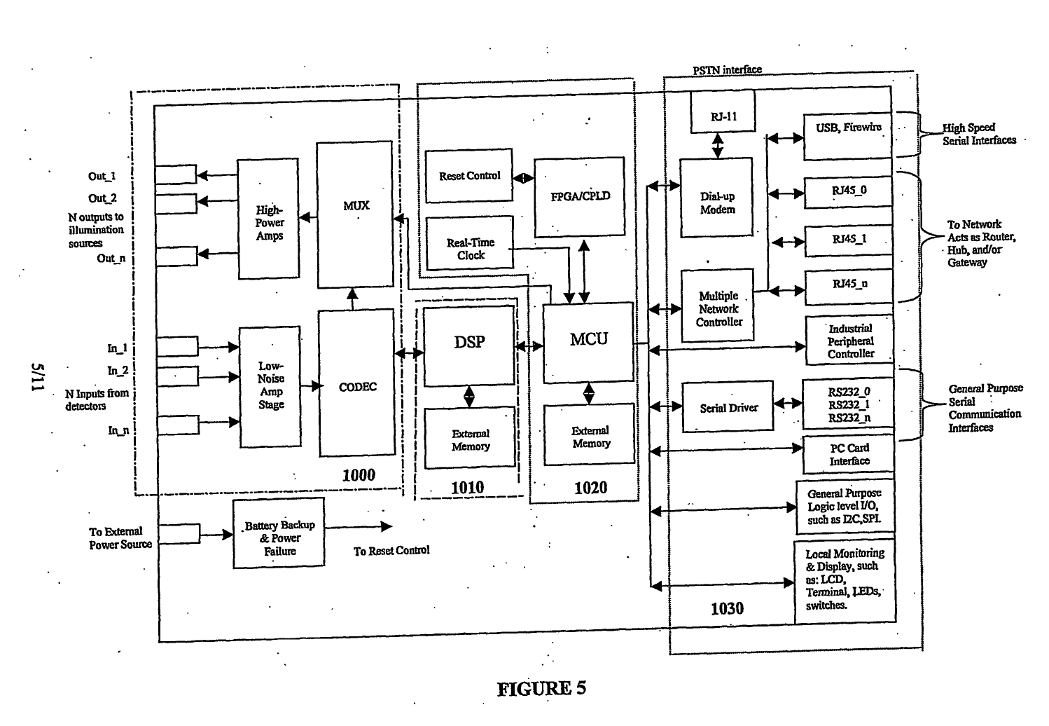

In one embodiment of the present invention, a schematic of a stand alone signal processing system is illustrated in FIG. 5. This signal processing system comprises a DSP block 1010, a transmitter and receiver block 1000, a micro-controller block (MCU) 1020 and a communication block 1030. The DSP block comprises elements including an analog low pass filter the signals received from the detector, an analog to digital converter, a digital to analog converter and an analog low pass filter for the control signals being sent to the energy source. The DSP block comprises elements including a bank of narrowband digital filters, a summation module, a filter pulse period buffer a pulse code correlator and a signal strength detector. The interrelationship between these elements in this stand alone signal processing system can be similar to that illustrated in FIG. 2, for example.

Weak Signal Detection

The weak signal detection is described in terms of the interconnection of the signal processing system according to the present invention with an optical sensing system. These techniques for weak signal detection can equally be applicable to the signal processing system being interconnected with an alternate sensing system, for example a photo-acoustic sensing system or an X-Ray sensing system. A worker skilled in the art would readily understand how to integrate these weak signal detection techniques into the signal processing techniques for use with an alternate sensing system.

In one embodiment, the tone-encoded method is used for signal encoding due to its basic simplicity and the fact that it yields a reasonable degree of noise suppression relative to the complexity. In this embodiment, the key consideration is the amount of time required to take one measurement. This is determined by: 1) the amount of time required to acquire the samples for a frequency domain transfer, which is essentially the number of samples required divided by the sample rate and 2) the filter bandwidth in the case of a bandpass filter technique, which is essentially the reciprocal of the bandwidth of the filter.

The trade-off with the electrical signal bandwidth is observation time versus noise. As the bandwidth is increased and the observation time is decreased, the noise power increases in proportion to the bandwidth. Any increase in noise reduces the detector sensitivity. The total processing time to scan the area of interest can be determined by T=Nτ, where τ is the time for one measurement at one wavelength. The two key variables in the observation time are the sensor filter bandwidth and the electrical filter bandwidth.

An example of a rough first order calculation of T can be made by making the following assumptions: 1) resolve optical spectra over the range 250 nm to 800 nm, 2) an optical resolution bandwidth of 10 nm, and 3) an electrical bandpass filter BW of 10 Hz, therefore τ=0.10 sec. By using these assumptions, the scanning time is 151.25 seconds, or about 2.5 minutes.

In many embodiments the detection of the frequencies of the reactive radiation characteristics is the primary goal. These reactive radiation characteristics are the frequencies emanating from the test that are different from the incident signal. For example, fluorescent light is a reactive radiation. Such reactive radiation is generally much weaker than the reflected light. The spectral resolution of the sensing system is required to be able to discriminate between reflected and fluorescent wavelengths. This may be achieved through the use of a prism and/or grating monochromators with variable apertures, which suppress stray radiation.

For optical signatures to be adequately resolved, the signal processing system must be able to detect very weak signals, which result from the optical radiation being detected by the detector. Ultimately, the goal is to be able to detect a very weak signal in a background of noise due to electrical noise, optical background radiation and out of band emissions from the test sample (due to the spectrometer spectral resolution).

Other variables in the measurement of spectral signatures comprise: a) time duration the test sample is illuminated; b) the amplitude of the illumination at the test sample first surface; c) the amplitude of the noise variables; d) spectral shifts in the illuminators over time; and e) the decay of the fluorescence emitted by a test sample after the illumination of the test sample has been discontinued. These variables need to be addressed to compare the performance of various detection schemes.

In one embodiment of the present invention, adaptive filtering of the received light may enable the detection of the decaying intensity of fluorescence emitted from a test sample upon the discontinuation of the illumination of the test sample. The discontinuation of the illumination may be a complete termination of the transmission of energy or the discontinuation of a particular illumination wavelength. The measurement of the decay of fluorescence emitted by a test sample using the sensing system controlled by the signal processing system according to the present invention may provide a means for the identification of a test sample.

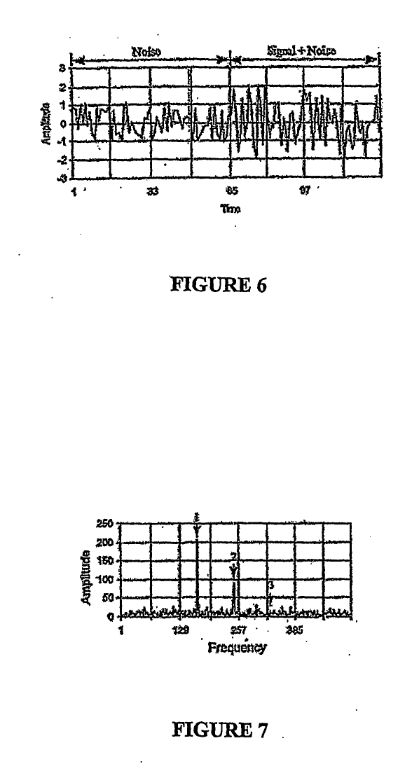

Pulse amplitude modulation techniques as applied to this situation may be On-Off keying of the illumination. The detection is based on the ability to detect the presence of a signal in an ambient noise. Signal detectability can depend on the ability to discriminate the signal from the noise and generally requires a signal power much greater than the noise (>10 dB typically). An example of an On-Off keyed signal is shown in FIG. 6. The signal to noise ratio (SNR) in this case is 0 dB and it is not possible to distinguish the noise portion of the signal from that consisting the signal plus noise.

The frequency domain detection mechanism is a detection means based on frequency modulation of the signal with a constant frequency modulation. This has a great advantage over time domain detection means such as On-Off keying. Even though the RMS amplitudes of the signal and the noise can be equal (SNR=0 dB), the power spectral density of the modulated signal is usually much greater than the power spectral density of the broadband noise. The carrier can be isolated from the noise by a number of means, including: a) spectral measurement techniques, such as a DFT or FFT, and b) narrow band filtering with the centre frequency of the filter located at the modulation frequency.

An example of this is shown in FIG. 7. In this case, the RMS amplitudes of the first signal and the noise are equal (SNR=0 dB). Two other signals were added which had magnitudes relative to the first signal of 0.50 and 0.1 respectively. The time domain signal happens to look exactly like that shown in FIG. 6. In the frequency domain however, the peaks for the first and second signals are apparent The signature for this signal is buried in the noise and cannot be resolved. This detection technique is relatively simple to implement in practice and can be suitable for use with a weak signal detection system.

The pulse coding techniques (binary, linear, enhanced) are an alternative means of detection. Pulse coding techniques are often used to detect very weak signals in the presence of noise. They may be more complex than traditional techniques such as tone detection and pulse amplitude detection, however they are sometimes a choice when amplitude of the signal to be detected is weak relative to the noise and there are no means available to increase the signal to noise ratio other than pulse coding. Two possible pulse coding techniques are Binary Pulse Coding and Linear Frequency Modulation (FM) Coding. Both of these techniques fall into the realm of pulse compression and spread spectrum and are described in numerous references including Barton, DK (1978) Radars Volume 3: Pulse Compression, Artech House Inc.

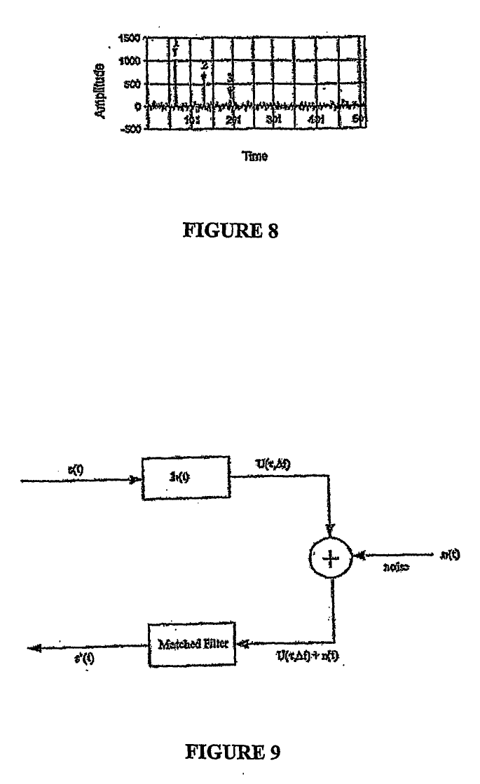

Binary Pulse Coding, as an example, uses a 1000-bit synchword, which can be created by using a uniform random number generator and constructing a binary sequence from that data. Pulses are generated at specific locations in the time domain and the relative amplitudes are measured. Results of a time domain correlation output are shown in FIG. 8. In an amplitude plot, all three pulses can be detected. The third and smallest signal pulse is just distinguishable from the noise.

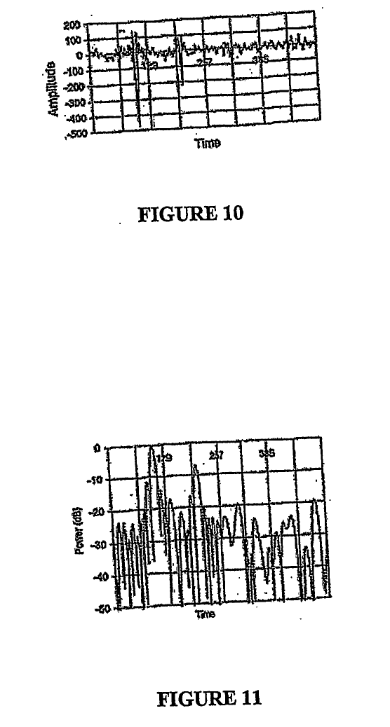

Linear FM Pulse Compression schemes have traditionally been used in radar systems to reduce the overall peak power of transmitted signals while still achieving large detection ranges. They also figure prominently in Synthetic Aperture Radar processing for airborne and spaceborne imaging radars. This form of coding is achieved by linearly sweeping a carrier signal from f₁ to f₂ (for a swept bandwidth of Δf) for a duration τ. In general, the “output power” of a linear FM coded signal is increased by the Time Bandwidth Product (TBP) Δfτ, which is the product of the pulse duration in seconds and the swept bandwidth in Hertz. The detection process is essentially a matched filter detector, which is matched to the linear FM transmitted pulse. The overall process is shown in FIG. 9. The signal s(t) can be a Dirac Delta function, which in reality is the trigger pulse for the encoder h(t) which generates the transmitted signal U(τ,Δf) which is the linear FM coded pulse (or Chirp) which has a duration τ and a bandwidth Δf. This is the signal that would drive an emitter to illuminate a test sample. Noise n(t) is added to the coded signal in both the system and the electronics. This signal is detected by a detector, whose electrical output signal comprises the actual signal of interest, system background noise and electrical noise in the detector and electronics. The matched filter detector subsequently processes this electrical signal. Since the signal of interest is only one of the three components of the signal that is matched to the matched filter, it is the only component which experiences gain due to the linear FM pulse coding. The system and electrical noise components are essentially suppressed relative to the coded signal. This is an advantage of such a scheme. A linear FM Chirp output is shown in FIG. 10. In the amplitude plot, only the largest two pulses can be detected, with the third being essentially buried in the noise. This example graphically demonstrates the coding gain offered by a linear FM Pulse Compression Technique.

Enhanced Pulse Coding Techniques take advantage of the fact that by increasing the Time Bandwidth Product; greater coding gain can be achieved. Using this technique the weakest of the time domain pulses was just visible.

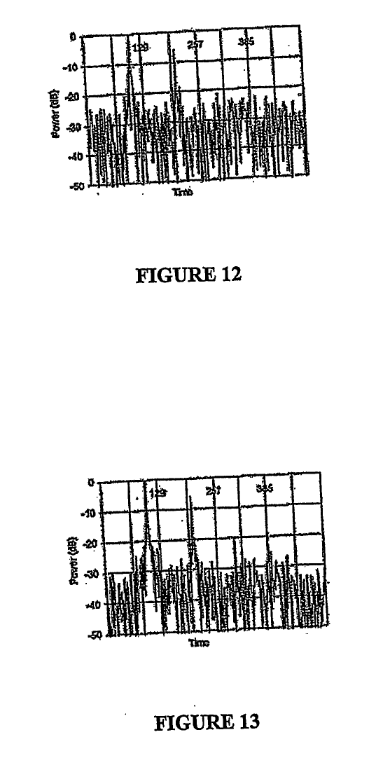

A plot of the original case with a TBP of 200 is shown in FIG. 11 and the new case with a TBP of 800 is shown in FIG. 12. The increase of the time bandwidth product has increased the coding gain sufficiently enough that the third and weakest pulse is now visible above the noise floor. The coding gain was increased from 23.0 dB to 29.0 dB or an overall increase 6.0 dB. In both plots, the power has been normalised to the peak located at sample 100. The drop in the noise floor in going from a TBP of 200 to 800 is readily apparent.

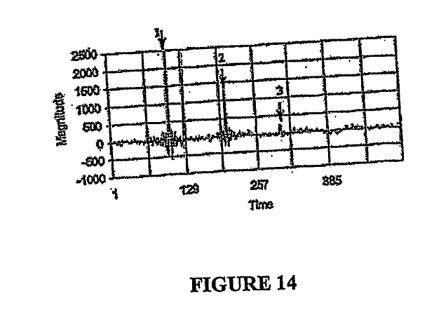

To further make this point, a plot for the case of a TBP of 2250 is shown in FIG. 13. In order to compare this high time bandwidth product detection scheme to the other coding techniques, a time domain magnitude plot where the detector amplitude has been plotted is shown in FIG. 14. The noise amplitude should be suppressed by √2250, or about 47.4. The peak amplitude of pulse 1 is 2505, pulse 2 is 1252 and pulse 3 is 250. The noise magnitude was the same as that for the signal for peak 1, therefore the noise magnitude should be suppressed to a level of approximately 52. As seen from FIG. 14, this is more or less the case. Due to the high level of noise suppression achieved, the signal for pulse 3 is quite visible relative to the noise background. This is readily apparent when the TBP=375 case in FIG. 10 where pulse 3 is not visible, is compared with the TBP=2250 case in FIG. 14 where pulse 3 is visible.

Higher Time Bandwidth Products can be used to achieve higher coding gains, however these may be limited depending on the means used to achieve the signal coding. A mechanical chopper would be limited by the ability to replicate the linear FM code onto the chopper wheel, whereas acoustic-optic modulators could achieve much higher TBP's but at much higher expense.

### EXAMPLES

### Example I

### Signal Processing System Integrated with an Optical System

In this example the signal processing system according to the present invention is integrated with an optical system. The combined sensing and signal processing systems comprise a light emitting diode (LED), as the illumination light source, which is controlled by said signal processing system to emit a radiation bandwidth ranging from 380 to 500 nanometers; b) a stepper motor controlled, grating monochromator which is controlled by said signal processing system to receive light from the illumination device and to deliver the N^{th} wavelength in a pulse sequence; c) an optical fibre probe that is coupled to the monochromator with collimating and focusing elements that delivers the N^{th} wavelength to the test sample, located in an assembly that orients the illumination optics with that of the collecting optics such that they are at a constant angle to each other; d) collecting means for gathering the resultant radiation of the N^{th} wavelengths and delivering the information via light collection lenses and fibre coupled to the stepper motor controlled, grating detection monochromator which is also controlled by the signal processing system for wavelength isolation; and e) a photodetector such as a Ga—As Integrated Photodiode and Amplifier.

The signal processing system further enables the creation of an illumination modulation coding signal using a 32 bit linear FM pulse coding technique for pulse coding of the illumination. The detection pulse coding is resolving the time bandwidth product with a matched correlation receiver, matched to the coding technique used, and the detection of specific amplitudes of irradiance can prompt the signal processing system to run a specific routine to test for specific signal response characteristics. For example, fluorescence and reflectance can be measured depending on the limitations of the wavelengths of illumination.

This example of the integration of the signal processing system of the present invention with an optical sensing system can enable the detection of reflection and fluorescence from a test sample due to its illumination by a particular wavelength.

### Example II

### Signal Processing System Integrated with an Optical System for Analyzing Fluid Samples

In another example of the signal processing system according to the present invention is integrated with an optical system designed to perform the analysis of fluid samples, for example for the detection of turbidity and/or bio-mass in a flowing water sample. This form of the signal processing system and an optical system may also be used for the analysis of a petroleum sample, for example. In this embodiment of the optical system the change(s) in the spectral properties of a test sample are detected and evaluated.

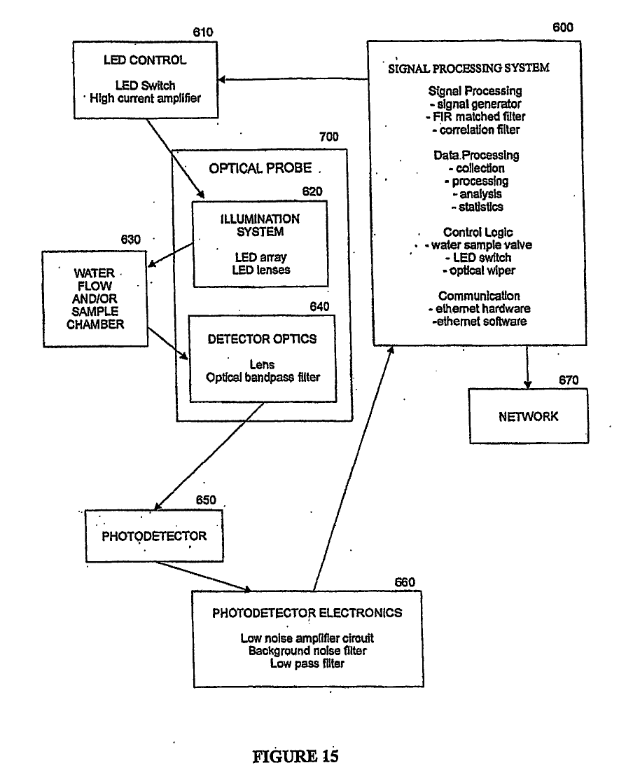

FIG. 15 illustrates an integrated system according to this example directed towards water analysis. The integrated system comprises a signal processing system 600, a LED control system 610, an illumination system 620, a sample chamber or water flow 630 into which the optical probe 700 may be placed, detector optics 640, a photodetector 650, photodetector electronics 660 and a network 670 to which the signal processing system 600 is connected. The optical probe 700 which can be inserted into the flowing water comprises both the illumination system 620 and the detector optics 640 which can be aligned in order to maximise the detection of radiation emitted by the water sample upon it illumination.

The signal processing system 600 comprises software and hardware integrated together to enable it to perform tasks including signal processing, data processing, system control through the use of control logic and communication with an external network for example the Internet or a local area network (LAN). The signal processing performed by the signal processing system includes the operation of the signal generator enabling the encoding of the illumination signal (radiation). In addition, the signal processing enabled by the signal processing system includes the FIR matched filtering and the correlation filtering of the received light signal (detected radiation emitted by the water sample). The data processing performed by the signal processing system can include the collection, processing and analysis of the collected data. A statistical analysis of the data may also be performed by the signal processing system in order to determine for example return periods of particular levels of detected radiation. The control of a valve for withdrawing a sample from a water flow into a sample chamber and the control of the LED switch thereby controlling the activation of a LED, are both provided by the control logic incorporated into the signal processing system. The control logic may additionally control an optical wiper that can be used to remove bio-fouling which may collect and grow on the optical probe. The inclusion of an optical wiper may reduce the frequency of the removal of the probe from the sample chamber or water flow, for cleaning. The signal processing system further comprises a communication system which enables it to connect with a network thereby enabling the transmission of the collected information to other sites without the need for personnel to visit the test site for data retrieval. In the present embodiment, this communication is provided by software and hardware which enables an Ethernet link to be created.

The LED control 610 includes the LED switch and a high current amplifier, wherein the LED switch activates the desired LED and the high current amplifier transforms the available power supply to a level which is compatible with the activation of a LED to a desired intensity level.

The optical probe 700 comprises both the illumination system 620 and the detector optics 640 wherein this probe can be inserted into the water flow directly or into a sample chamber containing water extracted from the water flow. If the probe is inserted into the moving water flow, the shape of the probe should be designed for minimal disruption of the water flow. The illumination system comprises a LED array and LED optics for focusing the photonic radiation generated by the LED array. The LED array may be a single diode or may be a collection of diodes thereby spanning a predetermined band of wavelengths. In one embodiment, a green and blue light emitting diode is used in the optical system. The detector optics comprise lens for collecting the radiation emitted by the water sample in addition to an optical bandpass filter for pre-filtering the collected radiation before it is detected by the photodetector 650 for conversion of the detected radiation into an electronic signal.

The photodetector electronics 660 comprise a collection of filters which pre-filter the collected information prior to its processing by the signal processing system, for example the match filtering of the collected information relating to the water samples illumination.

In this embodiment of the invention, the signal processing system is a stand-alone system which may include an internal power supply or a power converter. in order for the signal processing system to be interconnected to a standard AC power source, for example a wall socket. In addition, this stand-alone signal processing system enables the deployment of this integrated system at a plurality of sites, for example at various locations in a water supply system. Through the interconnection of this collection of integrated systems to a communication network, for example the Internet or a local area network, the information which is collected and processed by these integrated systems can be transmitted to a central site, without the need for personnel to visit each test site to collect the information. This type of integrated system may provide a means for efficiently and cost effectively evaluating a water supply system.

This integrated system is capable of detecting reflectance and fluorescence, wherein reflectance is indicative of the turbidity of the water sample and the fluorescence is indicative of the bio-matter contained within the water sample. It is known to a worker skilled in the art that bio-matter, upon its illumination will fluoresce and the detection of the intensity of fluorescence can potentially enable the determination of the level of bio-matter within a water system. This embodiment of the integrated system evaluates the changes in the reflectance and the fluorescence within the water flow, thereby potentially being able to identify situations which may be of particular relevance. In this manner, upon the detection of a particular level of change in the optical signature of the water flow, the signal processing system may be able to activate a sampling procedure, wherein a sample of the water flow is collected for laboratory analysis. This type of almost constant testing and selective laboratory analysis can potentially reduce the cost of monitoring a water supply system and increase the identification of a potential problem.

### Example III

### Signal Processing System Integrated with an Photo-Acoustic Sensing System

A further example integrates the signal processing system of the present invention with a photo-acoustic sensing system enabling modulation of an optical signal and the demodulation of an acoustic signal resulting from the illumination of the test sample. This integration of the signal processing system may provide a means for identifying features of a test sample based on acoustic response to selected electromagnetic radiation that may not be detectable using other techniques, for example evaluation of an optical response.

### Example IV

### Signal Processing System Integrated with an X-Ray Sensing System

Another example is the use of the signal processing system integrated with an X-Ray sensing system, whereby X-Rays or other high energy electromagnetic signals may used in the evaluation of atomic structures or other features, for example. Such types of electromagnetic radiation have been used for many years in the analysis of a wide range of organic and non-organic materials. With the integration of the signal processing system of the present invention, enhanced detection characteristic's of an X-Ray sensing device may be realised.

Despite the very small wavelength and the present ability to discriminate between dimensions on the scale of an atom, the use of a DSP system to modulate and demodulate the X-Ray signals offers opportunity for an improvement in performance of an X-Ray analysis system. These X-Ray detection systems comprise X-Ray reflectance, X-Ray absorption and X-Ray fluorescence systems.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A signal processing system for controlling a sensing system enabling the detection of signals in the presence of noise, said sensing system including an energy source for generating an incident signal, an emission processing system for directing the incident signal to a test sample, a received signal processing system for collecting one or more resultant signals from the test sample in response to the incident signal and a detector for converting the one or more resultant signals into electrical signals, said signal processing system comprising:
a) an emission control system operatively connected to the energy source and the received signal processing system, said emission control system transmitting first control signals to the energy source, said energy source thereby producing an encoded incident signal in a coded format, said emission control system sending second control signals to the received signal processing system for controlling the collection of the one or more resultant signals for subsequent conversion into electrical signals by the detector; and
b) a DSP received signal processing system for match correlating the electrical signals from the detector with the encoded incident signal thereby enabling isolation of a response of the test sample to the incident signal transmitted thereto in the presence of noise.

2. The signal processing system for controlling a sensing system according to claim 1, wherein the encoded incident signal is coded using a modulation technique selected from the group comprising pulse amplitude modulation, pulse frequency modulation, pulse width modulation, binary phase shift keying, a function generator or a mechanical method modulation.

3. The signal processing system for controlling a sensing system according to claim 1, wherein said match correlating is performed using a bank of narrowband filters and a summation module.

4. The signal processing system for controlling a sensing system according to claim 1, further comprising an integrated communication block enabling interconnection with a communication network, said communication network being selected from the group comprising local area network, wide area network, wireless network, the Internet or Ethernet.

5. The signal processing system for controlling a sensing system according to claim 1, wherein the sensing system is capable of sensing signals including electromagnetic signals comprising low frequency to X-Ray, acoustic signals and acoustic signals.

6. The signal processing system for controlling a sensing system according to claim 1, wherein the test sample is a fluid sample, or a biological sample.

7. The signal processing system for controlling a sensing system according to claim 1, wherein the test sample is in motion.

8. The signal processing system for controlling a sensing system according to claim 1, wherein the resultant signals are a reflection of the incident signal by the test sample or the resultant signals are fluorescence that results from an interaction between the test sample and the incident signal.
